(19) United States
(12) Patent Application Publication
(10) Pub. No.: US 2008/0245883 A1
(43) Pub. Date: Oct. 9, 2008

(54) PAINT APPLICATION APPARATUS AND SYSTEM WITH SAME

(76) Inventor: Kenneth Mikalsen, Bryne (NO)

Correspondence Address: ST. ONGE STEWARD JOHNSTON & REENS, LLC, 986 BEDFORD STREET, STAMFORD, CT, 06905-5619, US

(21) Appl. No.: 12/098,216

(22) Filed: Apr. 4, 2008

Related U.S. Application Data
(63) Continuation of application No. PCT/IB2006/053687, filed on Oct. 9, 2006.
(60) Provisional application No. 60/724,959, filed on Oct. 7, 2005.

(51) Int. Cl. B05B 5/00; F16L 11/127

(52) U.S. Cl. 239/3; 138/137; 138/134; 239/690

(57) ABSTRACT

An insulated hose for a high voltage paint application apparatus comprising an inner hose containing a fluid or paint charged at a high voltage. The inner hose is arranged inside at least one second insulating layer. A system for applying paint or other fluid materials at a high voltage is also described.

### CROSS-REFERENCE TO RELATED APPLICATIONS

The present application is a continuation of pending International patent application PCT/IB2006/053687 filed on Oct. 9, 2006 which designates the United States and claims the benefit of U.S. Provisional Patent Application No. 60/724,959, filed Oct. 7, 2005, the content of which is incorporated herein by reference.

### FIELD OF THE INVENTION

The invention relates to a device forming part of an apparatus for applying paint or other fluid materials with a high voltage paint application apparatus or system. In particular the invention relates to an improved supply line hose capable of insulating a paint supply in a high voltage painting system.

### BACKGROUND OF THE INVENTION

The present invention is related to a supply line hose for use in a spray painting apparatus or installation. The spray painting apparatus provides for a dosed paint supply to the applicator or spray gun, and in particular for the case in which the applicator is charged at a high voltage for electrical atomizing of a electrically conductive paint or other fluid. Such a spray painting apparatus must be well insulated, explosion-proof and reliable, without being excessively difficult or expensive to implement. When painting with direct charge of the fluid, using a conductive paint, the fluid in the hose will be charged with a voltage that may typically be up to 150 kV or so. For this reason, application with direct charge of conductive fluids such as water borne paints requires an effective insulation or galvanic blocking between a spray gun/applicator charged with a high voltage and apparatus at zero or ground potential, in particular a paint dosing device and/or the paint lines supplying the dosing device.

An international patent application WO IB2004/003104 (Anfindsen et al), assigned to ABB, which is hereby incorporated in full by means of this reference, describes an improved spray painting system with a dosing device. In particular it describes means for achieving a galvanic block, or voltage block, between the dosed fluid in contact with a high voltage and the fluid in the supply lines or paint kitchen etc which is normally at ground potential. In this description a dosing device is described which comprises one or more dosing cylinders which may be filled at a paint supply point, moved away from the supply point and towards a spray head connection point or docking head of a valve block for handling colour painting and flushing operations, and from there connected to one or more spray heads. A supply line so connected between a dosing cylinder connection point or valve block and a applicator or spray head has to insulate the spray head at high voltage from the paint supply in the dosing cylinder or valve block.

### SUMMARY OF THE INVENTION

An embodiment of the present invention provides an improvement to an insulated supply conduit in the form of a flexible hose for a paint application apparatus maintained in part at a high voltage comprising an inner hose containing a paint or other fluid maintained at a high voltage, arranged inside at least one second insulating layer. Another embodiment of the present invention provides an improvement to an insulated supply conduit in the form of flexible high voltage hose comprising an insulation gap arranged between the inner hose and the at least one second insulating layer containing air or another insulating fluid.

Another embodiment of the present invention provides an improvement to an insulated supply conduit in the form of a flexible hose for a paint application apparatus wherein an insulation gap arranged between the inner hose and the at least one second insulating layer contains air, a gas or a mixture of gases from which any contaminants have been removed.

According to another embodiment of the present invention an improvement is provides to an insulated supply conduit in the form of a flexible hose for a paint application wherein the external surface of the hose is partly covered by a conductive or non-insulating layer which is connected to a ground or earth terminal. Another embodiment of the present invention provides an improvement wherein the external surface of the hose is partly covered by a conductive or non-insulating layer comprising a metal tape, wire or filament which is connected to a ground or earth terminal. According to another embodiment an improvement is provided whereby the conductive or non-insulating layer around the hose and connected to ground or earth potential does not extend the full length of the hose and is limited to within a predetermined distance from at least one connection point of the hose.

According to another aspect of the invention a system is provided for applying paint or other fluid materials to a substrate comprising at least one robot which is equipped with a paint application apparatus maintained in part at a high voltage comprising an improved flexible high voltage hose which comprises an inner hose containing a paint or other coating material which is arranged surrounded by at least one second insulating layer. Another embodiment of the invention provides a system for applying paint or other fluid materials to a substrate wherein the improved flexible hose comprises an insulation gap arranged between the inner hose and the or at least one second insulating layer which insulation gap contains air or another insulating fluid.

According to another embodiment of the invention an improved system for applying paint or other fluid materials to a substrate is provided wherein the improved flexible hose comprises an insulation gap arranged between the inner hose and at least one second insulating layer which insulation gap contains air or another insulating fluid from which contaminants have been removed.

The invention may be summarily described as comprising a flexible and insulated hose for a paint spraying apparatus. When painting with direct charge of the paint or fluid, the paint in the hose will be charged with a voltage that may typically be up to 150 kV or so. The fluid hose must be able to conduct paint or fluid from a supply point such as a valve block, a dosing cylinder or other supply means to the applicator or spray head. The hose must insulate the fluid from the grounded surroundings. The hose should not be charged on the external surface, and at the same time it must be flexible, so that the hose can be routed over moving joints. This is achieved according to an embodiment of the present invention by including a plurality of insulating hoses inside each other, arranged such that there is a small gap between each hose; and where the insulation value is dependent on the total material thickness from the hoses. The provision according to an embodiment of the invention of a hose comprising at least two layers arranged with a small gap between them allows the hose to be flexible.

The principal advantage of such an improved insulated and flexible hose according to an embodiment of the invention is that the paint handling systems, the paint lines and the paint kitchen are isolated from those system parts, principally the applicator, that are charged at a high voltage during operation. Providing a flexible and insulated supply line between docking head or valve block and applicator enables a robust apparatus and system for painting and coating that may also be operated in a flexible way with full freedom to include paint changes, colour changes and/or flushing sequences efficiently. The flexible insulated hose is able to insulate the fluid from the grounded surroundings without the hose being charged on the surface, and at the same time be flexible, so that the hose can be routed over a moving joint such as that between an robot arm and a spray gun or applicator. Such a flexible hose may also be used to supply paint to applicators or spray heads arranged fitted on simpler machines than multi-axis robots, machines such as reciprocating painting machines, Cartesian robots, or machines that operate on only one or two degrees of freedom.

Another benefit of the flexible hose is that it typically permits use of a relatively short hose across the joint. This provides for more economic production as less paint is lost from the short line during colour changing or flushing. In addition the flexible hose may be arranged adjacent an external surface of the painting apparatus or robot. An external hose provides for simplified maintenance as it is quick and easy to inspect and also to access for repair or replacement if necessary.

### BRIEF DESCRIPTION OF THE DRAWINGS

The invention will now be further explained by means of exemplary embodiments and with reference to the accompanying drawings, on which:

FIG. 1 shows a cross-section view of an improved flexible hose for a paint application apparatus, maintained in part at a high voltage, according to an embodiment of the invention;

FIG. 2 shows a schematic arrangement for part of a painting apparatus comprising a flexible hose according to an embodiment of the invention,

FIG. 3 shows a schematic arrangement for part of a painting apparatus comprising a flexible hose according to another embodiment of the invention;

FIG. 4 shows a cross-section view of an improved flexible hose for a paint application apparatus, maintained in part at a high voltage, according to another embodiment of the invention.

### DETAILED DESCRIPTION OF THE INVENTION

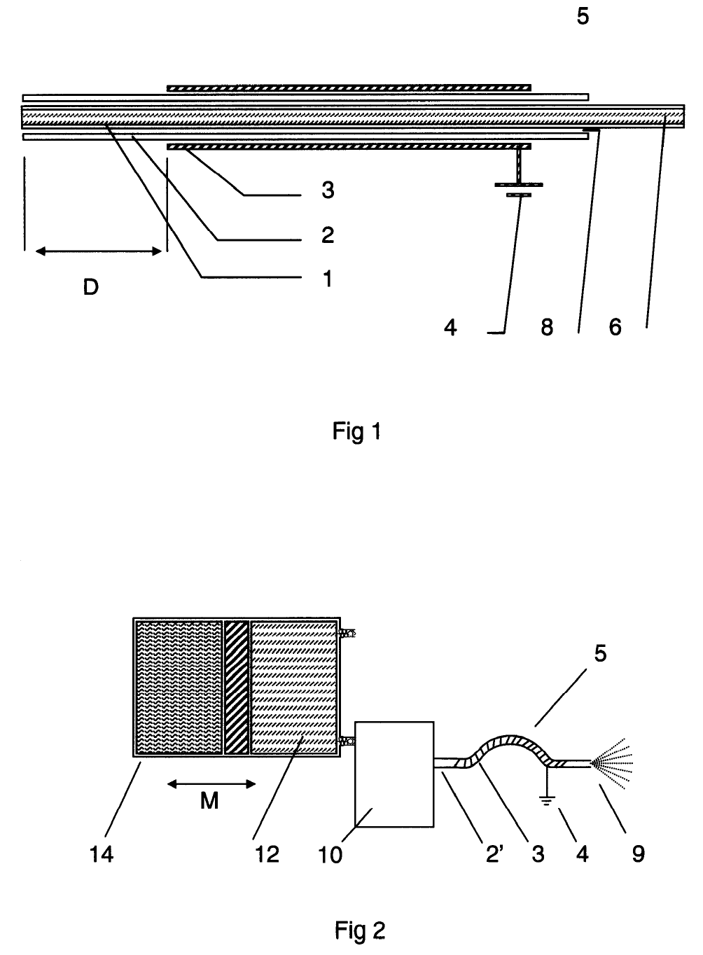

FIG. 1 shows a schematic diagram of a high voltage hose 5 according to an embodiment of the invention. The figure shows a hose 5 conducting paint 6 or another fluid material. Hose 5 comprises an inner hose 1 which is surrounded by a second hose 2. Between the first hose 1 and second hose 2 is arranged a non-conducting fluid such as air 8. Surrounding part of the outer surface of second hose 2 is a conducting or non-insulating layer 3 which is grounded at least one point 4. The conducting or non insulating layer 3 does not extend over the whole length of the hose, and may be arranged a predetermined distance D away from a point on at least one end of the hose where the hose is connected to apparatus at ground potential.

The required insulation value is achieved by arranging a plurality of insulating hoses inside each other, and also arranged with a small gap between each hose. The total material thickness from the plurality of hoses gives the insulation strength value. The use of multiple layers with a small gap between allows the hose to be flexible. In the simplest embodiment air may be used to fill the gap. However the inventors have determined that any air in the air gap must be thoroughly cleaned of any contaminants, such as any contaminating particles. This thought to be because presence of particles or similar contaminants in the air gap may cause insulation breakdown at the surface of the insulating hose such as in the form of partial discharges.

FIG. 2 shows a schematic and simplified block diagram for a part of a paint application apparatus including a high voltage hose 5 according to an embodiment of the invention. The figure shows a dosing cylinder 14 containing conducting paint 6 or other fluid material. The dosing cylinder 14 is moveable as indicated by arrow M and may be connected to a docking head 10. The docking head typically comprises a valve block or other valve means for routing paint and/or flushing solvent as desired to the spray head, or for changing paint colour, and/or may have valve means for flushing the docking head connection point and for conducting waste paint and flushing liquid away to a waste collection means.

The docking head is connected by hose 5 to a spray gun or applicator 9. The outer surface of the hose 5 is covered in part by a conductive or non-insulating layer 3 which is connected to a ground 4. The conductive or non-insulating layer 3 may not extend for the whole length of the hose and may instead stop a predetermined distance away from one or both ends of the hose.

During a painting operation the surface of the exterior hose will over time tend to accumulate a static charge. This static charge is eliminated according to an embodiment of the invention by grounding part of the surface of the exterior hose. This is done by arranging the exterior hose with the conductive flexible layer 3 which is connected to ground 4. The grounded layer must be limited to within a safe distance D away from one or both end/connecting points of the fluid hose. The external conductive or at least non-insulating layer may comprise a metal tape, for example a copper tape. The tape may be arranged wound around the outermost layer in different patterns, with gaps between adjacent turns or without. The gaps between adjacent turns may be specified to a predetermined amount. Other non-insulating materials such as conductive or semi-conducting metals plastics or composites may be substituted for the copper tape. The conductive or non-insulating layer for grounding the external surface of the hose may alternatively be provided with a layer by other covering means, and may comprise a continuous layer, filaments other structure.

A paint application apparatus maintained in part at a high voltage comprising an insulated and flexible hose according to an embodiment of the invention is able to insulate the paint or fluid from the grounded surroundings without the hose being charged on the surface, and at the same time be flexible, so that the hose can be routed over a moving joint such as that between an robot arm and a spray gun or applicator. Such a paint application apparatus may be arranged connected to a robot equipped with one or more applicators. One or more such paint application apparatus may be arranged mounted on one or more robots of the multi axis type. Such a flexible hose as described may also be used to supply paint to applicators or spray heads arranged fitted on simpler machines than multi-axis robots, machines such as Cartesian robots, or reciprocating painting machines, side or top machines, or other machines that operate using only one or two degrees of freedom.

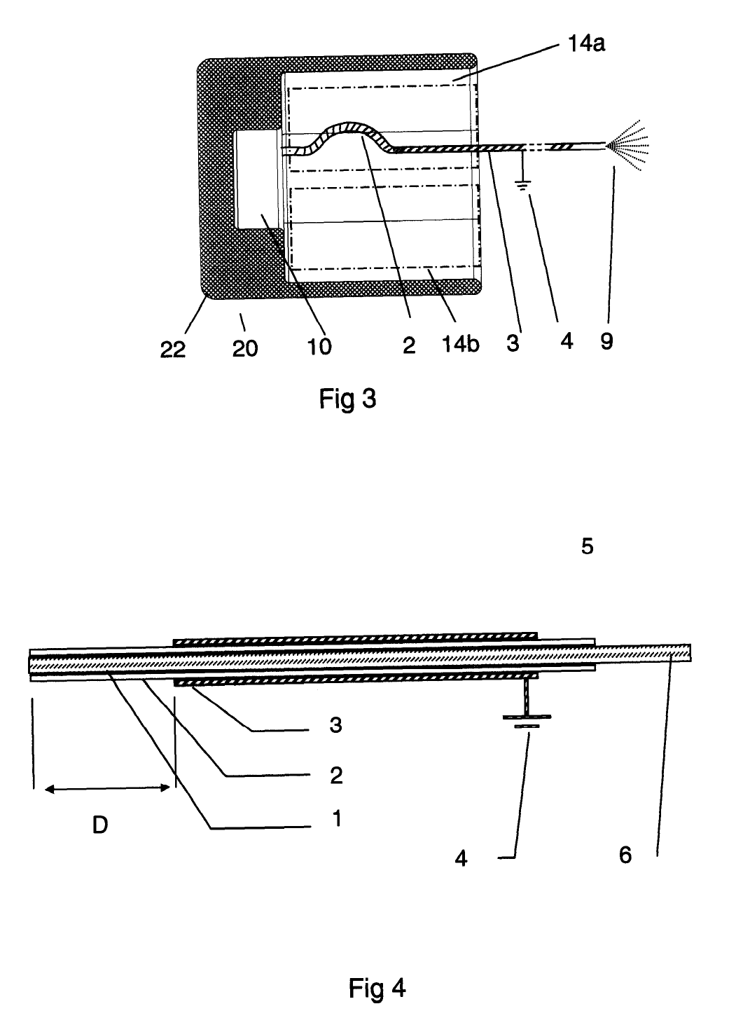

FIG. 3 shows a part of a paint application apparatus comprising the flexible HV hose according to another embodiment of the invention. The figure shows an insulation cover 20 arranged to partly cover a docking head 10 and two dosing cylinders 14a, 14b shown with dotted lines as they are inside the cover. The figure shows a flexible HV hose connected to the docking head 10 at one end and leading out under the insulation cover for connection to an applicator head 9 at the other end. The flexible HV hose conducts dosed paint from the docking head 10 to the applicator or spray gun 9. It is covered with a non-insulating layer 3 which is grounded, except for part of the hose in close proximity to the connection points at the docking head and again close to the applicator.

It should be noted that while the above describes exemplifying embodiments of the invention, there are several variations and modifications which may be made to the disclosed solution without departing from the scope of the present invention as defined in the appended claims.

In another, preferred embodiment shown schematically in FIG. 4, the flexible hose has a HV insolating layer in the form of a second hose 2. However second hose 2 is arranged adjacent the inner flexible hose 1 containing the fluid 6 at a high voltage. In a development of this embodiment, the second hose 2 may comprise a semiconducting material arranged in contact with the high voltage flexible hose 1. The inventors have found that addition of semiconducting material, such as distributed amount of semiconducting carbon black particles for example, reduces charge build-up at the boundary or interface between the first inner high voltage flexible hose 1 and the second hose 2. The semiconducting material may be distributed evenly across the material cross section of the second hose, or with a variable distribution over the hose cross section.

1. An insulated high voltage hose for a paint application apparatus maintained in part at a high voltage, wherein said hose comprises a flexible inner hose containing a fluid at a high voltage arranged inside at least one second insulating layer and the external surface of the hose is partly covered by a conductive or non-insulating layer.

2. The insulated hose according to claim 1, wherein said conductive or non-insulating layer is connected to a ground or earth terminal.

3. The insulated hose according to claim 2, wherein the external surface of the hose is partly covered by a conductive or non-insulating layer comprising a metal tape, wire or filament which is connected to a ground or earth terminal.

4. The insulated hose according to claim 3, wherein the external surface of the hose is partly covered by a tape comprising metallic copper.

5. The insulated hose according to claim 4, wherein the external surface of the hose is partly covered by a nonmetallic conducting or semi-conducting tape, wire or filament which is connected to a ground or earth terminal.

6. The insulated hose according to claim 1, wherein the external surface of the hose is partly covered by a conductive or non-insulating layer comprising a metal tape, wire or filament connected to a ground or earth terminal.

7. The insulated hose according to claim 2, wherein the conductive or non-insulating layer is wound around the insulating cover in a spiral fashion such that successive turns of the conductor are not arranged side-by side and/or not in contact with each other.

8. The insulated hose according to according to claim 7, wherein the conductive or non-insulating layer is wound around the insulating cover in a spiral fashion such that successive turns of the conductor are spaced apart and arranged at a predetermined distance from each other.

9. The insulated hose according to claim 2, wherein the conductive or non-insulating layer is wound around the insulating cover and that successive turns of the conductor are arranged side-by-side and/or touching.

10. The insulated hose according to claim 2, wherein the conductive or non-insulating layer around the hose and connected to ground or earth potential does not extend the full length of the hose and is limited to within a predetermined distance from at least one connection point of the hose.

11. The insulated hose according to claim 1, wherein the flexible inner hose, the at least one second insulating layer and the conductive or non-insulating layer, are arranged adjacent and in contact with each other.

12. The insulated hose according to claim 1, wherein the at least one second insulating layer, comprises a semiconducting material.

13. A system for applying paint or other fluid materials comprising at least one robot equipped with a paint application apparatus maintained in part at a high voltage, the paint application apparatus comprising an insulated high voltage hose, wherein the hose is a flexible hose and comprises an inner hose containing a paint or other coating material arranged surrounded by at least one second insulating layer.

14. The system according to claim 13, wherein at least one robot is arranged comprising a paint application apparatus maintained in part at a high voltage which paint application apparatus is program controlled.

15. The system according to claim 14, wherein at least one robot comprises a paint application apparatus maintained in part at a high voltage which comprises an insulated hose arranged suitably connected to the docking head in order to supply paint or other fluid via a docking valve and docking head to one or more applicators or spray heads.

16. The system according to claim 13, wherein at least one paint application apparatus maintained in part at a high voltage is arranged on a reciprocating machine for painting and movement in a single axis or two axes.

17. The system according to claim 13, wherein at least one paint application apparatus maintained in part at a high voltage is arranged on a Cartesian robot for painting and movement in a single axis or two axes.

18. The system according to claim 13, wherein the flexible inner hose of the insulated high voltage hose and the at least one second insulating layer are arranged adjacent and in contact with each other.

19. The system according to claim 13, wherein the at least one second insulating layer comprises a semiconducting material.

20.-21. (canceled)

22. A Method for applying fluid material to a substrate comprising the steps of:
a) maintaining at least a part of the hose at high voltage;
b) providing a hose having an insulating outer layer;
c) introducing fluid material into the hose; and
d) spraying the fluid material on the substrate.

23. The method according to claim 22, further comprising the step of providing a robot, and wherein the hose is provided as a component of the robot.

24. The method according to claim 22, in which the fluid material is paint.

25. The method according to claim 22, in which the spraying step further comprises flexing the hose.

26. The method according to claim 22, in which the spraying step further comprises moving the hose in reciprocating fashion.
